(19) United States
(12) Patent Application Publication
(10) Pub. No.: US 2016/0057516 A1
(43) Pub. Date: Feb. 25, 2016

(54) TRANSCEIVERS FOR SIGNAL SWITCHING ARCHITECTURE

(71) Applicant: Coriant Advanced Technology, LLC, New York, NY (US)

(72) Inventors: Michael J. Hochberg, New York, NY (US); Ran Ding, New York, NY (US); Ari Novack, New York, NY (US); Peter D. Magill, Freehold, NJ (US); Richard C. Younce, Yorkville, IL (US)

(21) Appl. No.: 14/832,377

(22) Filed: Aug. 21, 2015

Related U.S. Application Data
(60) Provisional application No. 62/040,233, filed on Aug. 21, 2014.

(51) Int. Cl. H04Q 11/00; H04J 14/06; H04B 10/40

(52) U.S. Cl. CPC H04Q 11/0005; H04B 10/40; H04J 14/06; H04Q 2011/0022; H04Q 2011/0016

(57) ABSTRACT

An architecture for a fiber optic communication system that uses only two levels of switches, Tier 1 and Tier 3, is described. The architecture allows one to omit the conventional Top of Rack switch level and the conventional Tier 2 switch level while maintaining performance and throughput. The cost to construct and install the improved switch architecture is lower than the cost of the conventional architecture. There are also described a number of transceivers that are suitable for use in the architecture disclosed. The transceivers employ silicon PIC chips that include high contrast silicon waveguides ion the chip and that connect to various configurations of optical fibers. The transceivers provide enhanced switching capacity with fewer devices.

### CROSS-REFERENCE TO RELATED APPLICATIONS

This application claims priority to and the benefit of co-pending U.S. provisional patent application Ser. No. 62/040,233, filed Aug. 21, 2014, which application is incorporated herein by reference in its entirety.

### FIELD OF THE INVENTION

The invention relates to signal switching architectures for data communication in general and particularly to signal switching architectures for communication over optical fibers.

### BACKGROUND OF THE INVENTION

Signal switching architectures for use in very large data centers have employed four levels (or tiers) of switches and require the use of very large amounts of optical fiber to interconnect them. This results in switching architectures that are complex and that are quite expensive. The switching equipment is expensive and the large amount of optical fiber is also a big expense.

A significant problem in the data center is the cost of running a very large number of fibers from point to point. While single-mode transceivers have existed for many years, they have generally either transmitted light into one fiber and received it in a second, separate fiber (i.e., a fiber pair), or they have made use of very widely separated wavelengths for transmission and reception (i.e., 1310 nm and 1550 nm).

There is a need for signal switching architectures that are more compact and that are less costly to construct and install.

### SUMMARY OF THE INVENTION

According to one aspect, the invention features an integrated photonic transceiver, comprising: an optical signal transmitter section; an optical signal receiver section; and an on-chip filter configured to combine one or more transmission wavelengths in an outgoing optical signal having wavelengths that are distinct from one or more received wavelengths in an incoming optical signal, in a single fiber connected to the integrated photonic receiver.

In one embodiment, the integrated photonic transceiver is fabricated in silicon.

In another embodiment, the filter is selected from the group consisting of a narrowband filter, a short wavelength cutoff filter, a long wavelength cutoff filter, and a bandpass filter.

In yet another embodiment, two data streams are transmitted and two are received, one in each of a TE and a TM polarization.

In still another embodiment, a photonic polarization controller is provided that is configured to combine data streams having two polarizations for transmission.

In a further embodiment, the integrated photonic transceiver comprises a coherent transmitter.

In yet a further embodiment, the coherent transmitter is configured to use QPSK formats.

In an additional embodiment, a photonic polarization controller is provided that is configured to separate data streams received into two polarizations.

In one more embodiment, the integrated photonic transceiver comprises a coherent receiver.

In still a further embodiment, the coherent receiver is configured to use QPSK formats.

In one embodiment, the integrated photonic transceiver comprises a plurality of receivers.

In another embodiment, the integrated photonic transceiver comprises a plurality of transmitters

According to another aspect, the invention relates to an integrated photonic transmitter array, comprising: an array of signal sources each connected to an optical transmitter section that provides a plurality of optical signals, each optical signal of the plurality of optical signals at a wavelength different from the wavelengths of the other optical signals; and a selected one of an arrayed waveguide grating, an echelle grating, a Mach-Zehnder interferometer-based multiplexer and an interleaver configured to provide an output signal having a plurality of the wavelengths on a single fiber.

In one embodiment, the integrated photonic transmitter array is fabricated in silicon.

In another embodiment, each of the array of signal sources comprises a laser source in optical communication with a modulator; the modulator having an input configured to receive information to be modulated onto a carrier optical signal.

In yet another embodiment, each of the signal sources is coupled to the selected one of the arrayed waveguide grating, the echelle grating, the Mach-Zehnder interferometer-based multiplexer and the interleaver by way of a filter.

In still another embodiment, the filter is selected from the group consisting of a narrowband filter, a short wavelength cutoff filter, a long wavelength cutoff filter, and a bandpass filter.

In a further embodiment, the integrated photonic transmitter array further comprises laser reflectors to provide tunable lasers, in combination with an external gain chip made of III/V semiconductor material.

In yet a further embodiment, at least one of the array of signal sources is a semiconductor laser.

In an additional embodiment, at least two data streams are transmitted and at least two data streams are received, one in each of a TE and a TM polarization.

In one more embodiment, a photonic polarization controller is provided that is configured to combine data streams having two polarizations for transmission.

In still a further embodiment, the integrated photonic transmitter array comprises a coherent transmitter.

In one embodiment, the coherent transmitter is configured to use QPSK formats.

In another embodiment, a photonic polarization controller is provided that is configured to separate data streams received into two polarizations.

In yet another embodiment, the integrated photonic transmitter array comprises a plurality of transmitters.

According to another aspect, the invention relates to an integrated photonic receiver array, comprising: an optical signal receiver section; and a selected one of an arrayed waveguide grating, an echelle grating, a Mach-Zehnder interferometer-based multiplexer and an interleaver configured to split a plurality of wavelengths received on a single fiber into individual beams each having a single wavelength distinct from the wavelengths of the other split beams.

In one embodiment, the integrated photonic receiver array is configured to receive a combined data stream comprising a plurality of polarizations.

In another embodiment, the combined data stream comprises two data streams, one in each of a TE and a TM polarization.

In yet another embodiment, the integrated photonic receiver array further comprises a photonic polarization controller configured to separate data streams received into two polarizations.

In still another embodiment, the integrated photonic receiver array comprises a coherent receiver.

In a further embodiment, the coherent receiver is configured to use QPSK format.

In yet a further embodiment, the integrated photonic receiver array comprises a plurality of receivers.

According to another aspect, the invention relates to an integrated photonic transceiver, comprising: an optical transmitter section; an optical receiver section; and a directional coupler configured to enable transmission and reception of outgoing and incoming optical signals on an optical fiber connected to the integrated photonic receiver.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 is a schematic diagram of the switching and communication architecture of a data center, showing the components and their interconnection in the data center.

FIG. 2 is a schematic diagram of the data center of FIG. 1 at a high level.

FIG. 3 is a schematic diagram of one embodiment of a transceiver.

FIG. 4 is a schematic diagram of an alternative embodiment of a transceiver.

FIG. 5 is a schematic diagram of is an embodiment of an array of transceivers.

FIG. 6 is a schematic diagram of is yet another embodiment of a transceiver.

FIG. 7 is a schematic diagram of a link between two data centers.

FIG. 8 is a schematic diagram of another embodiment of a transceiver.

FIG. 9 is a schematic diagram of another embodiment of a transceiver.

FIG. 10 is a schematic diagram of another embodiment of a transceiver.

### DETAILED DESCRIPTION

In the following description, various acronyms are used, each of which is defined hereafter in the section headed ACRONYMS AND TRADE NAMES.

The data center architecture and the various transceiver implementations allow the use of just two levels of switches, Tier 1 and Tier 3, rather than the more common 4-level data center architecture. The new architecture provides at least comparable performance in an arrangement having fewer devices and at lower overall installed cost.

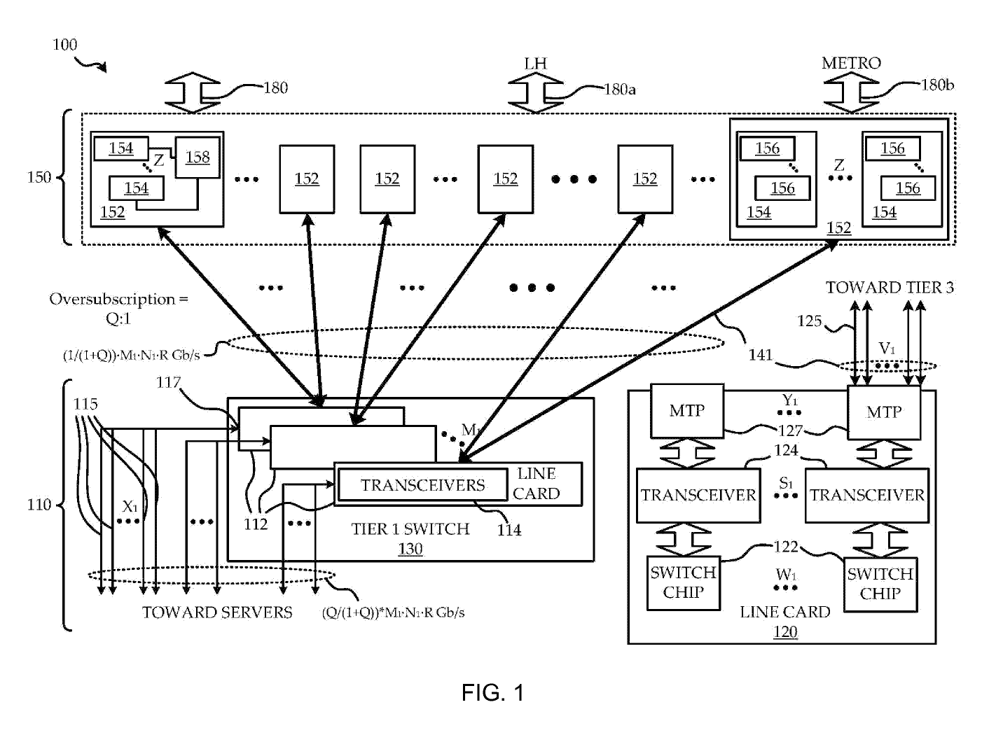

FIG. 1 is a schematic diagram of the switching architecture 100 of a data center, showing the components and their interconnection in the data center. In FIG. 1 there are only two switch levels, Tier 1 110 and Tier 3 150, as compared to a four-level architecture that is commonly used today, in which there is a Top of Rack (TOR) level, a Tier 1 level, a Tier 2 level, and a Tier 3 level. The architecture that is described in the present application is therefore a simpler, less expensive to construct, architecture in which the switches have increased capacity per level. As will be seen, each of Tier 1 and Tier 3 includes one or more switches. The required capacity for a given data center is provided by using at least one switch or a plurality of switches.

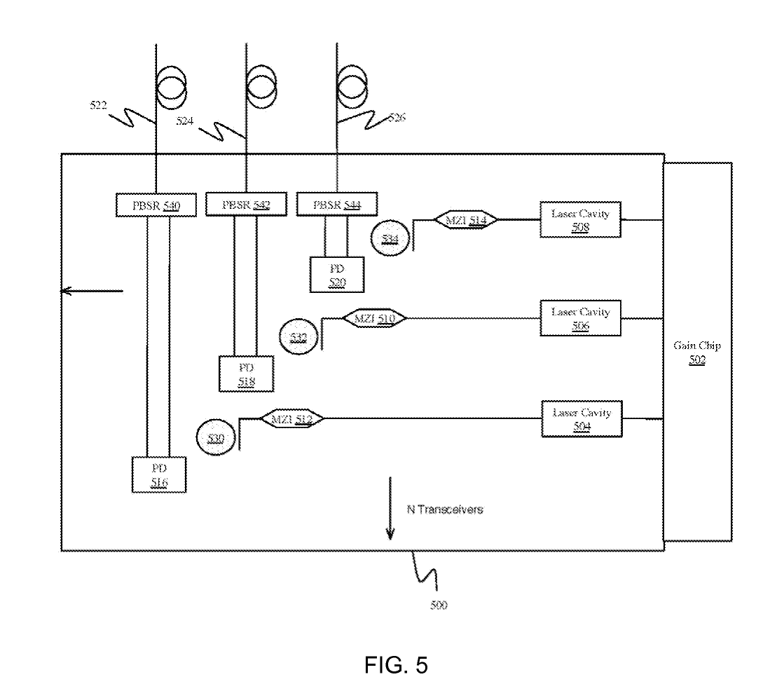

At the lower left of FIG. 1 there are illustrated designs for connection to one or more servers, which are not shown, but which are conventional servers such as rack mounted servers in an electronics rack. In one embodiment, the connection is between a server and a line card 112 of a Tier 1 switch 130 of Tier 1 110. Although for clarity only one Tier 1 switch 130 is illustrated, as mentioned hereinabove, Tier 1 110 may include one or more Tier 1 switches 130. A plurality of line cards 112 which include portions that are server-facing are shown in the lower center of FIG. 1. In one embodiment, the connection between a server and a line card 112 is provided by transceivers at each end communicating over bi-directional optical fibers 115 each transceiver having one transmitter that operates at a first wavelength (λ₁) with a capacity of R Gb/s, and having one receiver that operates at a second wavelength (λ₂) with a capacity of R Gb/s. At the line card 112 end, the connector 117 is a multi-fiber connector having a plurality of fibers, for example X₁ fibers, each of which has the capacity just recited. Each line card 112 may include one or more connectors 117 and includes transceivers 114 such as a transceiver implemented in a photonic integrated circuit (PIC) such as a parallel multi-transceiver module according to the design of transceiver B described in association with FIG. 5.

Turning to the line cards 112 of FIG. 1, which comprise a portion of a Tier 1 switch 130, there can be one or more line cards 112, each having a substantially similar capacity. For example, in one embodiment of a line card 112, there can be N₁ fiber optic input/output (I/O) ports connected to transceivers 114 which are electrically connected, directly or indirectly, to one or more entirely electronic switch chips. In another embodiment, a Tier 1 switch 130 can be comprised of an array of similar M₁ line cards (some facing the servers, some facing Tier 3 150) and an array of switch-fabric cards (not shown), with a total capacity of N₁×M₁×R Gb/s.

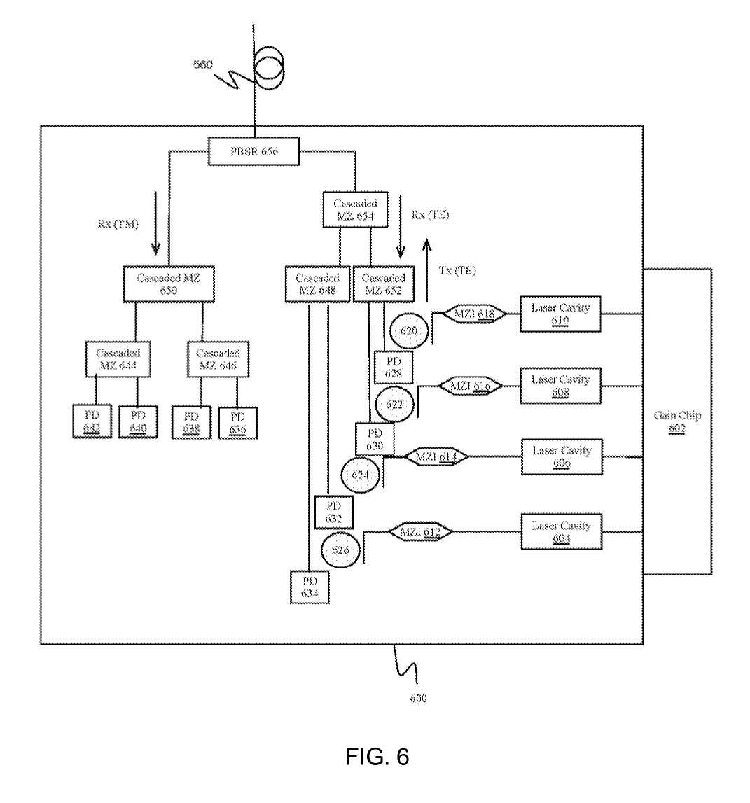

As illustrated on the right hand side of FIG. 1 at the Tier 1 level 110, a second line card 120 embodiment which includes portions which are Tier 3-facing according to principles of the invention has one or more (W₁) entirely electronic switch chips 122 (which using conventional technology can be one or more electronic switching chips which are commercially available from Broadcom, Cavium, and Barefoot Networks). The line card 120 has in-card connections from the switch chips 122 to one or more (S₁) transceivers 124 implemented in photonic integrated circuit chips (such as parallel multi-transceiver modules according to the design of transceiver B or transceiver C described in association with FIG. 5 or FIG. 6, respectively) to one or more (Y₁) multi-fiber connectors 127 such as an MTP connector, each connector 127 having a capacity of V₁ optical fibers 125 (V₁), such as fibers having a capacity of one or more streams of R Gb/s in each direction. In general, optical fibers used in devices according to the principles of the invention are bi-directional SM fibers or unidirectional SM fibers unless otherwise described. In some embodiments the capacity V₁ of each multi-fiber connector 127 is equal to 12 or more. Although not illustrated, serializer-deserializers are utilized within the switch chips 122 to interface with the transceivers 124. It should be understood that line cards including both the server facing portions and the Tier 3 facing portions described above are contemplated. It is contemplated that in some embodiments transceivers 124 comprise WDM transceivers configured to transmit and/or receive optical signals with use of multiple wavelengths, and in some embodiments each transceiver 124 is a transceiver module including multiple parallel WDM transceivers. It should be understood that photonic integrated circuit chips may be silicon-based, indium phosphide-based, or based on any other compatible material platform.

In the middle of FIG. 1 there are shown a number of connections 141 between Tier 1 switches 130 and Tier 3 switches 152. Each such connection line 141 is intended to denote an optical fiber bundle or ribbon, in one embodiment having 12 fibers, using an MTP connector to mechanically connect the fibers to the Tier 1 and Tier 3 switches 130, 152, and each bundle having a capacity of 400 G. In other embodiments the numbers and capacities of the various components and connections of the architecture 100 of FIG. 1 are such that a fiber bundle connecting Tier 1 110 and Tier 3 150 has a capacity of 800 G, as for example in the case of a pair of fibers operating with 32 wavelengths each, unidirectionally.

As illustrated at the top of FIG. 1, there are one or more Tier 3 switches 152 provided for switching of traffic between Tier 1 switches 130 and to enable optical communication 180 from the data center of FIG. 1 to other data centers (for example a long haul (LH) connection 180a), to other communication systems in the vicinity (for example within 80 kilometers, otherwise termed a “Metro” connection 180b), or for other types of optical connection. The Tier 3 level 150 of switches 152 in general are comprised of one or more chassis 154 here referred to as a multi-chassis switch 152. The chassis 154 can be assembled in arrays such as an array of Z Tier 3 chassis 154 (as shown on the leftmost example of a Tier 3 switch 152) with all of the chassis 154 interconnected by a switching fabric 158 (of which only one is illustrated). It should be noted that FIG. 1 illustrates an embodiment with an oversubscription of server bandwidth of Q:1 to the total capacity tying Tier 1 110 to Tier 3 150 which in one embodiment is 3:1. In other embodiments it is contemplated that other oversubscription ratios (the ratio of the total server-facing capacity to the total Tier 3-facing capacity) will be implemented. As shown in FIG. 1, since a Tier 1 switch 130 has many more ports than a top-of-rack switch as is used today, the range of oversubscription ratios that are possible in the architecture is greater than that normally possible when using a top-of-rack switch in known architectures.

In the next example of a Tier 1-Tier 3 architecture, which might be used in connection with a Metro connection 180b, there are shown in one embodiment a plurality of Tier 3 linecards 156, each of which has a capacity of P₁×100 G, to provide a capacity of P₂×100 G using multiple cards. As shown in the rightmost example switch 152, for some embodiments, these Tier 3 linecards 156 form part of each chassis 154. Other embodiments, using different numbers of Tier 3 linecards 156 may be constructed. The primary role of the Tier3 switches 152 is to interconnect all of the Tier 1 switches 130. In addition there will be a smaller number of links to optical devices external to the data center.

It should be understood that the variable labels used to enumerate and quantify various aspects of the architecture depicted in FIG. 1 (R, X₁, M₁, Z, Q, V₁, Y₁, S₁, W₁, P₁, P₂, N₁, etc.) are not illustrated as limited to any particular value, as skilled persons in the art will understand each can take on any one of a number of possible values which is compatible with the particular implementation of the architecture being contemplated. It should be understood that variations of the embodiment of the data center shown in FIG. 1 are contemplated. They include one or more of different electronic switch chips, different capacities, and different data rates on the interconnecting fiber bundles, for example.

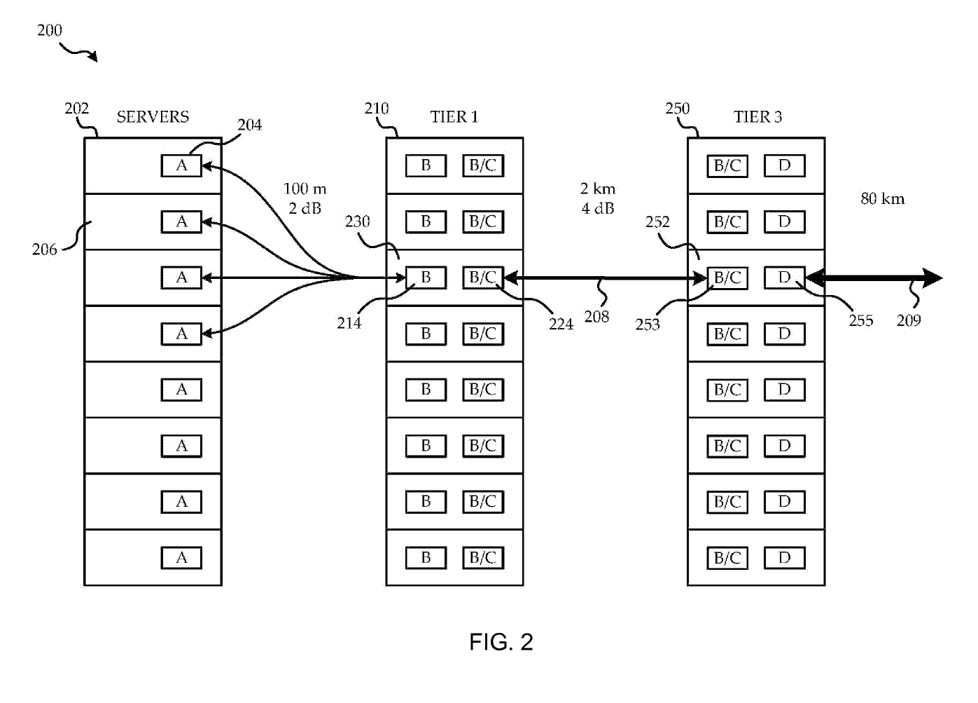

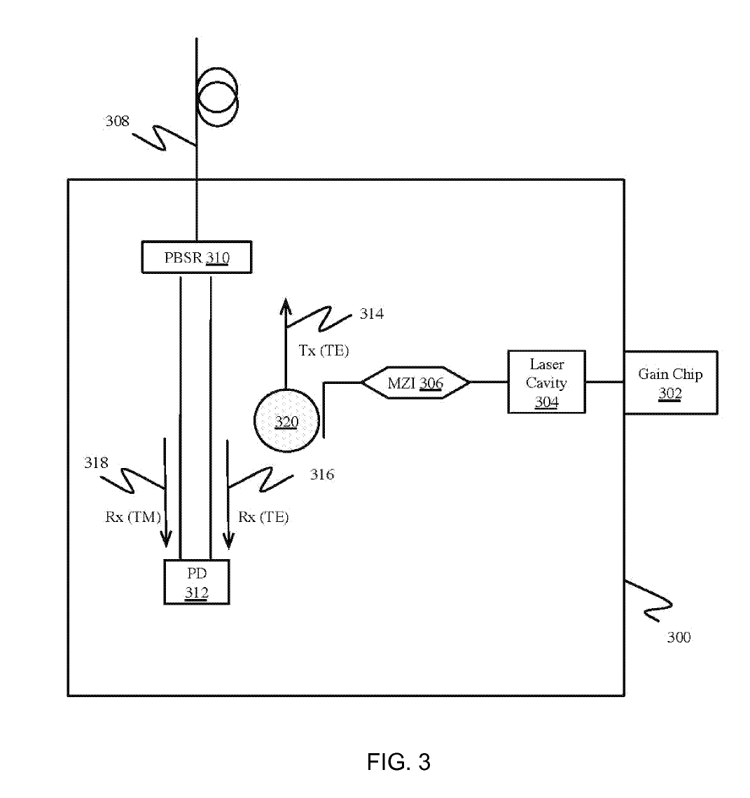

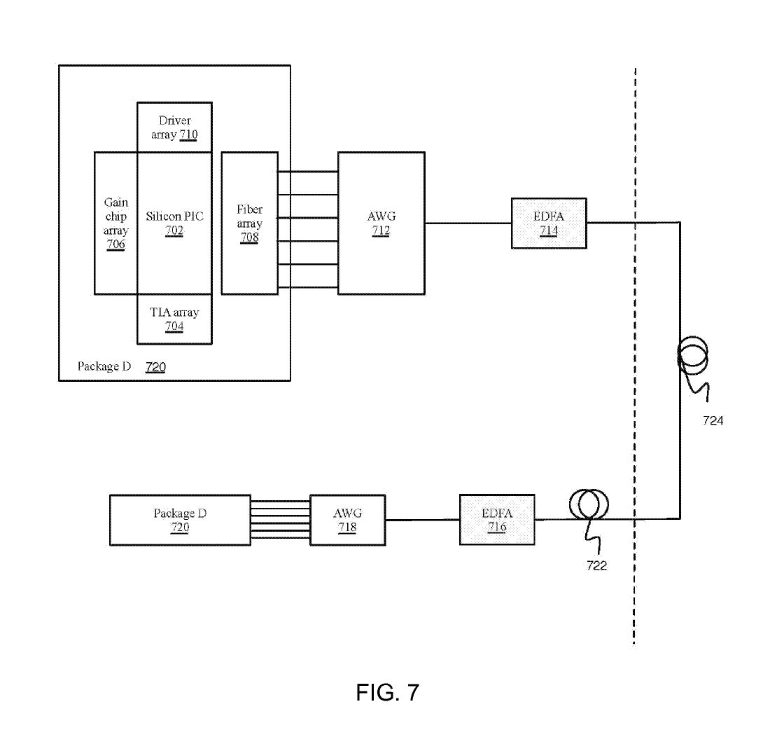

FIG. 2 is a schematic diagram of the architecture 200 of the data center of FIG. 1 at a high level. As shown in FIG. 2, a single server 206 within a server rack 202 containing a plurality of servers is connected by way of a transceiver 204 (such as transceiver A discussed in connection with FIG. 3) to a portion of a transceiver 214 (such as transceiver B discussed in connection with FIG. 5) within a Tier 1 switch 230. In one embodiment, the distance between the server rack 202 and the Tier 1 switch 230 is typically less than or equal to 100 meters, and experiences an optical loss of no more than approximately 2 dB. A connection 208 is shown between a Tier 1 switch 230 and a Tier 3 switch 252 using transceivers 224 and 253 (such as according to either the Transceiver B or Transceiver C design discussed in connection with FIG. 5 and FIG. 6 respectively). In one embodiment, the connection distance is expected to be less than or equal to 2 kilometers, with a loss of no more than 4 dB expected. Each Tier 3 switch 252 may then be optically connected to other (external) optical devices using one or more Metro links 209 utilizing a transceiver 255 (such as Transceiver D discussed in connection with FIG. 7-10) over a distance expected to be less than or equal to 80 kilometers. In other embodiments, the optical connection to external devices is a combination of long haul (LH) connections exceeding 80 km in length and Metro connections (not shown), for example to another data center.

In the present application, we describe a plurality of transceivers that are built using silicon photonics that will permit a significant reduction in the fiber count (50%) in the data center, by using a single fiber for bidirectional transmission.

FIG. 3 is a schematic diagram 300 of one embodiment of a transceiver. In FIG. 3, one embodiment of a Transceiver A is illustrated, which is based on a silicon PIC chip. In general, the on-chip optical connections on the silicon PIC chip are fabricated using high-contrast silicon optical waveguides, which are well known in the art. The data is encoded using a laser optical carrier, which in some embodiments may be generated using a semiconductor laser built from a gain chip 302 comprising a waveguide in a III-V material, a laser cavity 304, and a collection of waveguides and other optical elements on the silicon PIC chip. In some embodiments the data is encoded on the optical carrier using a Mach-Zehnder interferometer (MZI) 306 as a modulator. The modulator has an input configured to receive information to be modulated onto a carrier optical signal. The data signal is passed to a waveguide 314 for transmission using a device such as a ring resonator 320 which can be tuned to connect a specific wavelength of light onto the transmission line. In one embodiment, the TE mode is used for transmission. The transmitted signal passes through a polarization splitter and rotator (PSBR) 310 and is sent out to a bi-directional single mode (SM) optical fiber 308. In the receive direction, the transceiver receives optical signals from the bi-directional single mode optical fiber 308. In some embodiments, the signals may have an undefined state of polarization. The PBSR 310 splits the TE 316 and TM 318 modes of the incoming signal into two waveguides, each of which is leads to photodetector (PD) 312, causing the respective portion of the received signal to be detected. The detected signal can be further processed electronically.

A transceiver as shown in FIG. 3 may be constructed using any one of several embodiments, or combinations thereof, as are now described. In some embodiments, transmission and reception of optical signals occurs using the same wavelength, making use of directional couplers to separate the two data streams but incurring −6 dB of loss in total across the link. In other embodiments, transmission and reception of optical signals occurs using a filter to separate the transmission wavelength from the reception wavelength. In some embodiments, one can transmit modulated data, where the modulation is provided by a Mach-Zehnder interferometer, a ring resonator, or by using an electroabsorption modulator in silicon. In some embodiments, signal transmission may take advantage of polarization diversity to transmit more than one data stream. The receiver may do the same, by integrating a polarization controller into the optical path, along with an appropriate feedback algorithm. In some embodiments, the choice of wavelengths for transmission and reception may be auto-negotiated or may be fixed ab-initio. In some embodiments, the receiver may take advantage of coherent mixing with a local oscillator to enhance sensitivity. In various embodiments, transceivers that operate according to principles of the invention may embody a single device, feeding a single fiber, or an array of such devices, feeding an array of separate fibers. In various embodiments, dispersion compensation may be included as a block within the receiver or transmitter, either on a per-channel basis or as a single block for all channels.

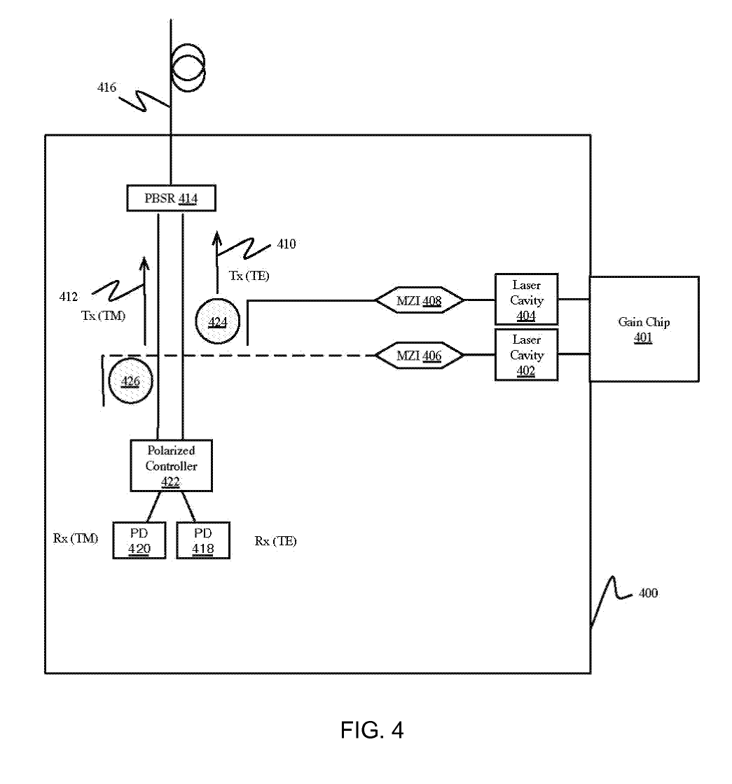

FIG. 4 is a schematic diagram 400 of an alternative embodiment of a transceiver. In FIG. 4 there are shown a gain chip 401, which contains two waveguides which together with further optical elements on the silicon chip (“laser cavity” 402, 404) generate two laser signals. The laser signals are carriers that can be modulated with information by Mach-Zhender interferometers 406, 408 to encode information on each carrier. In one embodiment, each of those laser signals feeds one of two parallel transmitters, one of which will produce a signal to be launched in TE mode on the bi-directional fiber 416, and the other of which produce a signal to be launched in the TM mode of the fiber 416. The modulated signals are coupled to one of the two parallel transmitters by way of respective ring resonators 424, 426 which can be used as a filter to tune a specific wavelength (or frequency) for passage, and to exclude other wavelengths. In other embodiments one can use one or more of a short wavelength cutoff filter, a long wavelength cutoff filter, and a bandpass filter. In some embodiments the bandpass filter is a narrow pass filter. The outgoing signals are combined in the PBSR 414 and applied to a bi-directional single mode optical fiber 416 for transmission. The incoming signals are handled in a manner similar to what was described for the transceiver of FIG. 3, using two photodetectors 418, 420, one for what was the TE mode and one for what was the TM mode of the fiber. However, in addition a polarization controller 422 is used to align the signals in the waveguides in such a way as to de-multiplex the originally polarization multiplexed signals.

FIG. 5 is a schematic diagram of is an embodiment of an array of transceivers. The transceiver of FIG. 5 is constructed using an array of N examples of transceiver A of FIG. 3 in a single silicon PIC chip (although only 3 devices are illustrated), where N is a positive integer number greater than 1. N will in general be bounded at a largest finite value constrained by packaging. Each of the three illustrated examples of transceiver A includes a gain chip 502 (which in some embodiments is a common gain chip and in other embodiments can be a separate gain chip for each transceiver), one of the laser cavities 504, 506, 508, one of the Mach-Zehnder interferometers 512, 510, 514, one of the ring resonators 530, 523, 534, one of the photodetectors 516,518, 520, one of the PBSRs 540, 542, 544, and one of the fibers 522, 524, 526.

FIG. 6 is a schematic diagram 600 of as yet another embodiment of a transceiver. The transceiver of FIG. 6 is an example of a transceiver C architecture, in which a gain chip 602 comprising an array of waveguides together with the array of silicon optical elements which constitute the remainder of the laser cavities 604, 606, 608, 610 provides signals, which are then encoded using devices (for example, MZIs 612, 614, 616, 618) similar to the device of FIG. 3. As illustrated in FIG. 6, a plurality (in the embodiment shown, 4) of transmitted signals are provided, for example having discrete wavelengths, λ₁, λ₂, λ₃, and λ₄. Each encoded signal at a given wavelength is handled by a respective ring resonator 626, 624, 622, 620. The transmitted signals are combined using cascaded MZIs 648, 652 654 (also sometimes referred to as “interleavers”), each MZI combining two signals onto a single waveguide. In various embodiments one can use a selected one of an arrayed waveguide grating, an echelle grating, a Mach-Zehnder interferometer-based multiplexer and an interleaver in performing the multiplexing. For 4 signals, two levels of cascaded MZIs are used (as is illustrated). For 8 signals, 3 levels of MZIs are used. In general, for N=2^{M} signals where M is a positive integer, M levels of MZIs will be required to combine all of the signals onto a single waveguide. The transmitted and received signals are communicated over a bi-directional SM optical fiber 560. The incoming signals pass through a PBSR 656 and are split into the TE and TM modes of the fiber. The TE signals propagate on the right hand side of the illustrated transceiver, and what had been the incoming TM mode signals on the left side. In one embodiment, the incoming signals are de-multiplexed based on wavelength into eight separate waveguides, each leading to a photodetector. The received electronic signals are processed substantially as described for the other transceivers. The demultiplexing is accomplished in the embodiment illustrated using cascaded MZIs 648, 652 654 for the incoming TE mode signal Rx(TE) and cascaded MZIs 650, 644 646 for the incoming TM mode signal Rx(TM). Photodetectors 634, 632, 630 and 628 are used to detect the four incoming Rx(TE) signals. Photodetectors 642, 640, 638 and 636 are used to detect the four incoming Rx(TM) signals. In various embodiments one can use a selected one of an arrayed waveguide grating, an echelle grating, a Mach-Zehnder interferometer-based demultiplexer and an interleaver in performing the demultiplexing.

All of the capabilities and methods of operation that are recited for Transceiver A above apply equally to various embodiments of transceiver C. In this embodiment, the transmitter and receiver each transmit and receive, respectively, more than one wavelength, in order to further increase the data transmission capacity of the system. In different embodiments, the wavelengths may be automatically negotiated, or may be fixed to a specific value for each channel in the grid or array. In some embodiments, dual polarization per wavelength is possible using a polarization controller. In cases of low wavelength dependent polarization mode dispersion (PMD) and polarization-dependent loss (PDL), the polarization controller may be shared among multiple wavelength channels (i.e., being located between the wavelength mux and the chip exit/entrance port). For other embodiments, the polarization controller can be provided on a per-channel basis. In various embodiments, arrays of multiple units of the same transceiver can be implemented on a single PIC. In some embodiments, the channel demux/mux capability may be provided by the use of ring resonators. In other embodiments, the channel demux/mux capability may be provided by the use of other filter elements.

FIG. 7 is a schematic diagram 700 of a link between two data centers. In FIG. 7, a detail of the contents of the package of a Transceiver D 720 is shown at the top left. The package for Transceiver D 720 includes a silicon PIC 702 which is connected to a gain chip array 706, an array of electronic drivers 710 to impress the data to be transmitted on the optical modulators within the PIC and an array of electronic TIA circuits 704 which are used to amplify the signals generated by incoming signals at photodiodes. The PIC 702 is connected to a fiber array 708. The signals from the fiber array are combined in an array waveguide grating (AWG) router 712 and transferred to a fiber leading to an Erbium-doped fiber amplifier (EDFA) 714 for transmission to a remote location. The EDFA 714 connects to a fiber 724, such as an 80 Km fiber external to the data center. A second Transceiver D 720 in the remote location is also shown. In one embodiment the remote location is another data center. In some embodiments, a dispersion compensating fiber (DCF) 722 is used to correct for chromatic dispersion that occurs in transmission through the 80 km external fiber 724. The DCF 722 can be placed at the transmitter data center or at the receiver data center. The incoming signals are amplified in an EDFA 716, demultiplexed in a second AWG 718, and processed in the second Transceiver D 720, which is substantially similar to the Transceiver D first described.

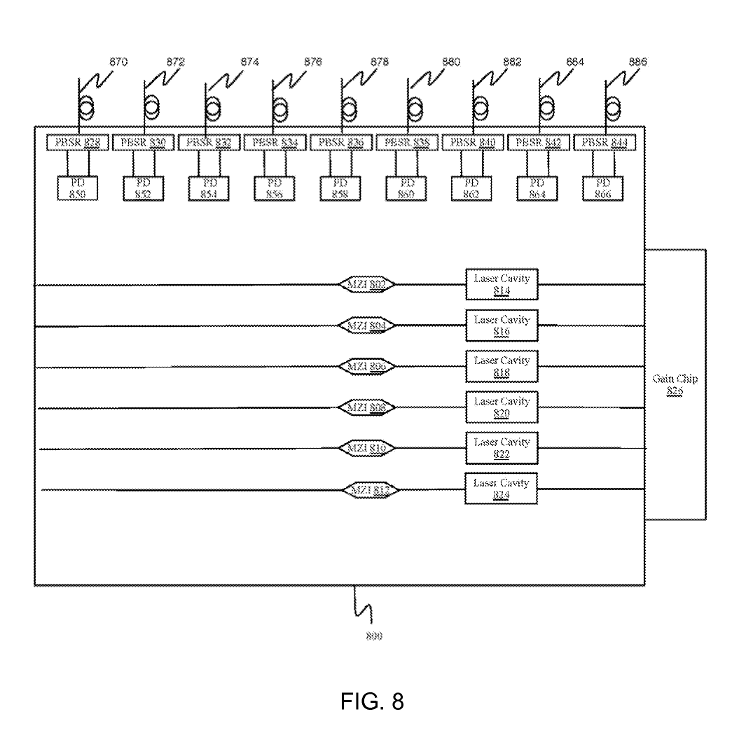

FIG. 8 is a schematic diagram 800 of another embodiment of a transceiver. In the transceiver of FIG. 8, a plurality of transceivers, each operating at 56 Gbaud are provided on a silicon PIC in an array. The number of transmitters and receivers is the same. As illustrated, there are only 6 transmitter section, each having connection to a gain chip 826, and including a laser cavity 814, 816, 818, 829, 822, 824 and a respective MZI 802, 804, 806, 808, 810, 812. The transmitted signals exit along the illustrated horizontal lines to the left of the drawing. As illustrated, there are 9 receiver sections, each connected to a fiber 870, 872, 874, 876, 878, 880, 882, 884, 886, which communicates the incoming signals to respective PBSRs 828, 830, 832, 834836, 838, 840, 842, 844 that split the incoming optical signal into TE and TM modes, and that communicate the split signals to photodetectors 85, 852, 854, 856, 858, 860, 862,864, 866, which detect the siognals and provide electrical signals representative of the optical signals.

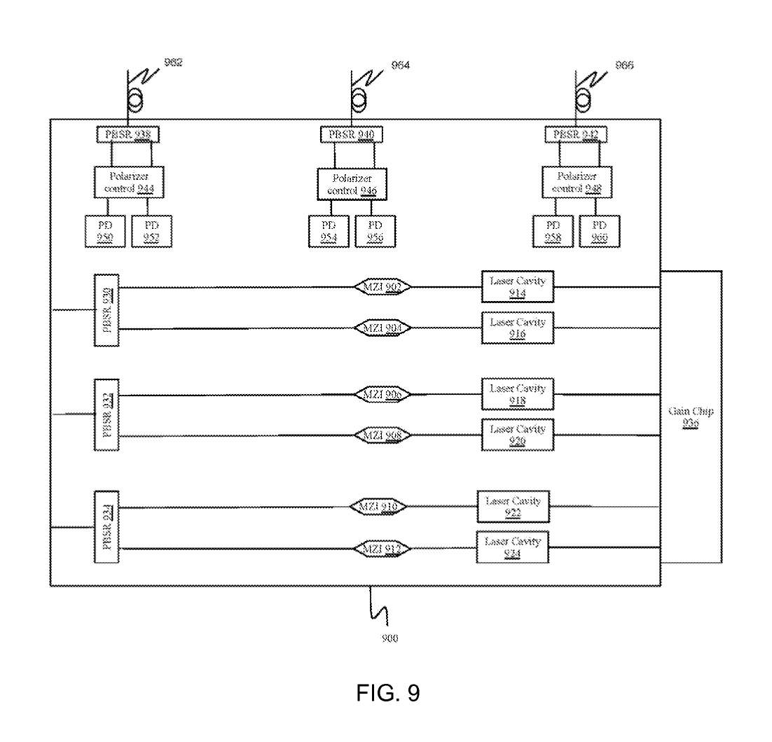

FIG. 9 is a schematic diagram 900 of another embodiment of a transceiver. The transceiver of FIG. 9 is an array of transceivers. The embodiment of FIG. 9 operates using pulse amplitude modulation on each of the two polarization components. One embodiment operates at 28 Gbaud and another embodiment operates at 56 Gbaud. Three transmitters are illustrated. The transmitters comprise a gain chip 936, respective laser cavities 914, 916, 918, 920, 922, 924, MZIs 902, 904, 906, 908, 910, 912, and respective PBSRs 930, 932, 934 that combine the outgoing optical signals and communicate the combined signals on an optical fiber. Three re4ceuivers are also illustrated. The receivers receive optical signals from respective fibers 962, 964, 966. The signals are split in PBSRs 938, 940 and 942. The split signals pass through polarization controllers 944, 946, 948. The separated optical frequencies and polarizations are then detected by photodetectors 950, 952, 954, 956, 958, 960.

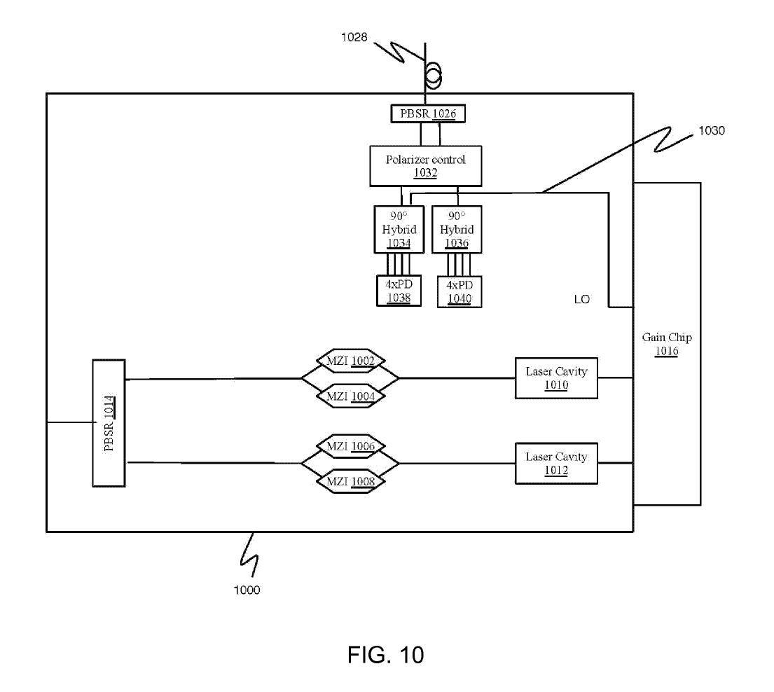

FIG. 10 is a schematic diagram 1000 of another embodiment of a transceiver. The transceiver of FIG. 10 operates using QPSK. In FIG. 10 the gain chip 1016 with the “laser cavity” elements 1010, 1012 on the PIC provides laser signals for the two branches of the transmitter and a local oscillator (LO) signal 1030 that can be used to analyze the phases in the incoming signals. The transmitter section includes two MZIs 1002, 1004 and 1006, 1008 per transmitter. The transmitter signals are combined in PBSR 1014 and provided to an optical fiber for transmission. In the receiver, signals enter from fiber 1028 and are split in PBSR 1026. A polarization controller 1032 provides signals to respective 90 degree hybrid mixers 1034 1036 and thereafter to 4×PD (four-fold photodetectors) 1038, 1040.

Various options for designs of package D that provide 100 Gb/s per channel can be considered. They include: 56 Gbaud DP OOK, 28 Gbaud DP-PAM4, 28 Gbaud DP-QPSK with LO, and 28 Gbaud DP-DQPSK direct detect.

FIG. 11 is a schematic diagram of an alternative architecture of a data center. The data center architecture in FIG. 11 is another embodiment of the data center shown in FIG. 1, which includes different capacities, and different data rates on the interconnecting fiber bundles, for example.

FIG. 12 is a schematic diagram of an alternative architecture of a data center. The data center architecture in FIG. 12 is another embodiment of the data center shown in FIG. 1, which includes different electronic switch chips, different capacities, and different data rates on the interconnecting fiber bundles, for example.

### ACRONYMS AND TRADE NAMES

OOK is on-off keying.

PAM is pulse amplitude modulation.

PAM4 is 4-level pulse amplitude modulation.

PSK is phase shift keying.

QPSK is quadrature or quaternary phase shift keying.

DQPSK is differential QPSK.

SM fiber is single mode fiber.

PBSR is polarization beam splitter and rotator.

PD is photodiode.

MZI is Mach-Zehnder Interferometer.

TE is transverse-electric mode.

TM is transverse-magnetic mode.

Tx is transmitter.

Rx is receiver.

TIA is transimpedance amplifier.

PIC is photonic integrated circuit.

AWG is array waveguide grating.

EDFA is Erbium doped fiber amplifier.

DCF is dispersion compensating fiber.

MTP is multi-termination parallel connector.

TOR is top of rack.

LH is long haul, meaning a connection of typically more than 80 kilometer distance, up to thousands of kilometers.

PMD is polarization mode dispersion.

PDL is polarization-dependent loss.

### DEFINITIONS

Unless otherwise explicitly recited herein, any reference to an electronic signal or an electromagnetic signal (or their equivalents) is to be understood as referring to a non-volatile electronic signal or a non-volatile electromagnetic signal.

Recording the results from an operation or data acquisition, such as for example, recording results at a particular frequency or wavelength, is understood to mean and is defined herein as writing output data in a non-transitory manner to a storage element, to a machine-readable storage medium, or to a storage device. Non-transitory machine-readable storage media that can be used in the invention include electronic, magnetic and/or optical storage media, such as magnetic floppy disks and hard disks; a DVD drive, a CD drive that in some embodiments can employ DVD disks, any of CD-ROM disks (i.e., read-only optical storage disks), CD-R disks (i.e., write-once, read-many optical storage disks), and CD-RW disks (i.e., rewriteable optical storage disks); and electronic storage media, such as RAM, ROM, EPROM, Compact Flash cards, PCMCIA cards, or alternatively SD or SDIO memory; and the electronic components (e.g., floppy disk drive, DVD drive, CD/CD-R/CD-RW drive, or Compact Flash/PCMCIA/SD adapter) that accommodate and read from and/or write to the storage media. Unless otherwise explicitly recited, any reference herein to “record” or “recording” is understood to refer to a non-transitory record or a non-transitory recording.

As is known to those of skill in the machine-readable storage media arts, new media and formats for data storage are continually being devised, and any convenient, commercially available storage medium and corresponding read/write device that may become available in the future is likely to be appropriate for use, especially if it provides any of a greater storage capacity, a higher access speed, a smaller size, and a lower cost per bit of stored information. Well known older machine-readable media are also available for use under certain conditions, such as punched paper tape or cards, magnetic recording on tape or wire, optical or magnetic reading of printed characters (e.g., OCR and magnetically encoded symbols) and machine-readable symbols such as one and two dimensional bar codes. Recording image data for later use (e.g., writing an image to memory or to digital memory) can be performed to enable the use of the recorded information as output, as data for display to a user, or as data to be made available for later use. Such digital memory elements or chips can be standalone memory devices, or can be incorporated within a device of interest. “Writing output data” or “writing an image to memory” is defined herein as including writing transformed data to registers within a microcomputer.

“Microcomputer” is defined herein as synonymous with microprocessor, microcontroller, and digital signal processor (“DSP”). It is understood that memory used by the microcomputer, including for example instructions for data processing coded as “firmware” can reside in memory physically inside of a microcomputer chip or in memory external to the microcomputer or in a combination of internal and external memory. Similarly, analog signals can be digitized by a standalone analog to digital converter (“ADC”) or one or more ADCs or multiplexed ADC channels can reside within a microcomputer package. It is also understood that field programmable array (“FPGA”) chips or application specific integrated circuits (“ASIC”) chips can perform microcomputer functions, either in hardware logic, software emulation of a microcomputer, or by a combination of the two. Apparatus having any of the inventive features described herein can operate entirely on one microcomputer or can include more than one microcomputer.

General purpose programmable computers useful for controlling instrumentation, recording signals and analyzing signals or data according to the present description can be any of a personal computer (PC), a microprocessor based computer, a portable computer, or other type of processing device. The general purpose programmable computer typically comprises a central processing unit, a storage or memory unit that can record and read information and programs using machine-readable storage media, a communication terminal such as a wired communication device or a wireless communication device, an output device such as a display terminal, and an input device such as a keyboard. The display terminal can be a touch screen display, in which case it can function as both a display device and an input device. Different and/or additional input devices can be present such as a pointing device, such as a mouse or a joystick, and different or additional output devices can be present such as an enunciator, for example a speaker, a second display, or a printer. The computer can run any one of a variety of operating systems, such as for example, any one of several versions of Windows, or of MacOS, or of UNIX, or of Linux. Computational results obtained in the operation of the general purpose computer can be stored for later use, and/or can be displayed to a user. At the very least, each microprocessor-based general purpose computer has registers that store the results of each computational step within the microprocessor, which results are then commonly stored in cache memory for later use, so that the result can be displayed, recorded to a non-volatile memory, or used in further data processing or analysis.

Many functions of electrical and electronic apparatus can be implemented in hardware (for example, hard-wired logic), in software (for example, logic encoded in a program operating on a general purpose processor), and in firmware (for example, logic encoded in a non-volatile memory that is invoked for operation on a processor as required). The present invention contemplates the substitution of one implementation of hardware, firmware and software for another implementation of the equivalent functionality using a different one of hardware, firmware and software. To the extent that an implementation can be represented mathematically by a transfer function, that is, a specified response is generated at an output terminal for a specific excitation applied to an input terminal of a “black box” exhibiting the transfer function, any implementation of the transfer function, including any combination of hardware, firmware and software implementations of portions or segments of the transfer function, is contemplated herein, so long as at least some of the implementation is performed in hardware.

### Theoretical Discussion

Although the theoretical description given herein is thought to be correct, the operation of the devices described and claimed herein does not depend upon the accuracy or validity of the theoretical description. That is, later theoretical developments that may explain the observed results on a basis different from the theory presented herein will not detract from the inventions described herein.

Any patent, patent application, patent application publication, journal article, book, published paper, or other publicly available material identified in the specification is hereby incorporated by reference herein in its entirety. Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

While the present invention has been particularly shown and described with reference to the preferred mode as illustrated in the drawing, it will be understood by one skilled in the art that various changes in detail may be affected therein without departing from the spirit and scope of the invention as defined by the claims.

1. An integrated photonic transceiver, comprising:
an optical signal transmitter section;
an optical signal receiver section; and
an on-chip filter configured to combine one or more transmission wavelengths in an outgoing optical signal having wavelengths that are distinct from one or more received wavelengths in an incoming optical signal, in a single fiber connected to said integrated photonic receiver.

2. The integrated photonic transceiver of claim 1, wherein said integrated photonic transceiver is fabricated in silicon.

3. The integrated photonic transceiver of claim 1, wherein said filter is selected from the group consisting of a narrowband filter, a short wavelength cutoff filter, a long wavelength cutoff filter, and a bandpass filter.

4. The integrated photonic transceiver of claim 1, wherein two data streams are transmitted and two are received, one in each of a TE and a TM polarization.

5. The integrated photonic transceiver of claim 1, wherein a photonic polarization controller is provided that is configured to combine data streams having two polarizations for transmission.

6. (canceled)

7. (canceled)

8. The integrated photonic transceiver of claim 1, wherein a photonic polarization controller is provided that is configured to separate data streams received into two polarizations.

9. (canceled)

10. (canceled)

11. The integrated photonic transceiver of claim 1, comprising a plurality of receivers.

12. The integrated photonic transceiver of claim 1, comprising a plurality of transmitters.

13. An integrated photonic transmitter array, comprising:
an array of signal sources each connected to an optical transmitter section that provides a plurality of optical signals, each optical signal of said plurality of optical signals at a wavelength different from the wavelengths of the other optical signals; and
a selected one of an arrayed waveguide grating, an echelle grating, a Mach-Zehnder interferometer-based multiplexer and an interleaver configured to provide an output signal having a plurality of said wavelengths on a single fiber.

14. The integrated photonic transmitter array of claim 13, wherein said integrated photonic transmitter array is fabricated in silicon.

15. The integrated photonic transmitter array of claim 13, wherein each of said array of signal sources comprises a laser source in optical communication with a modulator; said modulator having an input configured to receive information to be modulated onto a carrier optical signal.

16. The integrated photonic transmitter array of claim 13, wherein each of said signal sources is coupled to said selected one of said arrayed waveguide grating, said echelle grating, said Mach-Zehnder interferometer-based multiplexer and said interleaver by way of a filter.

17. The integrated photonic transmitter array of claim 16, wherein said filter is selected from the group consisting of a narrowband filter, a short wavelength cutoff filter, a long wavelength cutoff filter, and a bandpass filter.

18. The integrated photonic transmitter array of claim 13, further comprising laser reflectors to provide tunable lasers, in combination with an external gain chip made of III/V semiconductor material.

19. (canceled)

20. (canceled)

21. (canceled)

22. (canceled)

23. (canceled)

24. (canceled)

25. The integrated photonic transmitter array of claim 13, comprising a plurality of transmitters.

26. An integrated photonic receiver array, comprising:
an optical signal receiver section; and
a selected one of an arrayed waveguide grating, an echelle grating, a Mach-Zehnder interferometer-based multiplexer and an interleaver configured to split a plurality of wavelengths received on a single fiber into individual beams each having a single wavelength distinct from the wavelengths of the other split beams.

27. (canceled)

28. (canceled)

29. The integrated photonic receiver array of claim 26, further comprising a photonic polarization controller configured to separate data streams received into two polarizations.

30. The integrated photonic receiver array of claim 26, comprising a coherent receiver.

31. The integrated photonic receiver array of claim 30, wherein said coherent receiver is configured to use QPSK format.

32. The integrated photonic receiver array of claim 26, comprising a plurality of receivers.

33. (canceled)
